(19) United States
(12) Patent Application Publication
(10) Pub. No.: US 2018/0119826 A1
(43) Pub. Date: May 3, 2018

(54) THERMAL MANAGEMENT MODULE AND ROTARY VALVE THEREOF

(71) Applicant: Schaeffler Technologies AG & Co. KG, Herzogenaurach (DE)

(72) Inventors: Van Hau Nguyen, Shanghai (CN); Jens Schmaler, Stadt Wehlen (CN)

(73) Assignee: Schaeffler Technologies AG & Co. KG, Herzogenaurach (DE)

(21) Appl. No.: 15/572,811

(22) PCT Filed: May 25, 2016
(86) PCT No.: PCT/CN2016/083290

§ 371 Date: Nov. 9, 2017

(30) Foreign Application Priority Data
May 25, 2015 (CN) 201510270052.5

(51) Int. Cl. F16K 11/052; F16K 3/26

(52) U.S. Cl. CPC F16K 11/052; F01P 2007/146; F16K 3/26

(57) ABSTRACT

A thermal management module is provided that includes a housing, a rotary valve, and a sealing assembly arranged in a passageway of the housing. The sealing assembly includes a main seal, a secondary seal, and a seal support. The main seal is loose-fitting on the seal support and is loose-fitting in the housing, allowing rotation of the main seal. The rotating seal will wear uniformly, thereby reducing wear, and maintain good sealing performance throughout the lifetime of the thermal management module. The rotary valve can be configured with an opening that is asymmetric in relation to an axial direction of the rotary valve, thereby providing a rotational torque for turning the main seal. The opening of the rotary valve can have a die parting line that is inclined relative to the axial direction of the rotary valve, also providing a rotational torque for turning the main seal.

### CROSS-REFERENCE TO RELATED APPLICATIONS

This application is the U.S. National Phase of PCT Application No. PCT/CN2016/083290 filed Mar. 25, 2016 which claims priority to CN 201510270052 filed Mar. 25, 2015, the entire disclosures of which are incorporated by reference herein.

### TECHNICAL FIELD

This disclosure relates to a thermal management module and a rotary valve thereof.

### BACKGROUND

Thermal management modules are utilized in many vehicular systems, including internal combustion engines. A thermal management module can accurately control temperature, reduce preheating time, and increase the efficiency of the engine, transmission and turbocharger, etc., and also help to increase the efficiency and service life of vehicle parts.

For example, patent document DE 10 2013 209 582 A1 has disclosed a thermal management module. The thermal management module has multiple rotary valves and seals for sealing the rotary valves. The rotary valves are arranged in a housing of the thermal management module to rotate therein, and the rotary valves have multiple openings to communicate with cooling channels outside the housing. The seals are arranged between the openings of the rotary valves and the housing, and are pressed tightly with springs. Thus the rotary valves rotate to control pipelines such as cooling channels of an engine cooling system. The openings of the rotary valves of the thermal management module are symmetric with respect to cross sections of the rotary valves. The seals are fixed relative to the housing of the thermal management module. Thus, wear occurs between the rotary valves which can rotate and the seals which are fixed, and failure of sealing might result after a long period of operation of the rotary valves.

### SUMMARY

The object of the present disclosure is to provide a thermal management module and a rotary valve thereof, which thermal management module and rotary valve thereof can, by reducing a rotational torque requirement, provide better shifting behaviour or a smaller peak value of torque, and also provide improved wear behaviour between the rotary valve and a seal, or less seal wear.

The present disclosure achieves the previously described object by providing the following thermal management module.

According to an example embodiment, a thermal management module is provided, comprising: a housing, provided with a passageway; a rotary valve, arranged in the housing and having an opening, the opening being in fluid communication with an external channel outside of the housing via the passageway of the housing; and a sealing assembly, arranged in the passageway of the housing. The sealing assembly comprises a main seal, a secondary seal and a seal support; the seal support has a hollow cylindrical portion and a flange connected to an axial end of the cylindrical portion; the main seal and the secondary seal are arranged successively, in an axial direction of the passageway, in a space between the flange and cylindrical portion of the seal support and the housing; the main seal is in contact with the rotary valve in the axial direction of the passageway for the purpose of sealing the rotary valve, and the secondary seal abuts the main seal at one end and abuts the flange at another end in the axial direction of the opening, for the purpose of achieving sealing between the housing and the seal support, wherein the main seal is loose-fitting on the seal support of the sealing assembly and also loose-fitting in the housing of the thermal management module.

Thus, the loose fitting of the main seal in the housing and on the seal support allows rotation of the seal. The rotating main seal will wear uniformly, thereby reducing wear, and maintain good sealing performance throughout the lifetime of the thermal management module.

In an example embodiment, a width of an opening of the rotary valve is smaller than an internal diameter of the main seal. A peak value of shifting torque during operation of the rotary valve can thereby be reduced.

In an example embodiment, an opening of the rotary valve is asymmetric in relation to an axial direction of the rotary valve. A peak value of torque during operation of the rotary valve can be reduced by changing the design of the opening in the rotary valve, by an asymmetric opening design. The asymmetric opening in the rotary valve gives rise to an asymmetric force acting on the main seal, thereby increasing a rotational torque for turning the seal.

In an example embodiment, the asymmetric opening is a first asymmetric opening, and the rotary valve has a second asymmetric opening on a side opposite the first asymmetric opening in a radial direction of the rotary valve.

In an example embodiment, the first asymmetric opening and the second asymmetric opening are oriented in opposite directions. The rotary valve can have multiple asymmetric openings that can be oriented in opposite directions on opposite sides of the rotary valve. Thus, main seals used for opposite passageways will rotate in opposite directions, to compensate for an axial reaction force caused by rotation of a main seal at the rotary valve.

In an example embodiment, the first asymmetric opening and the second asymmetric opening are oriented in a same direction.

In an example embodiment, an asymmetric opening of the rotary valve has a die parting line that is inclined relative to the axial direction of the rotary valve. By changing the design of die parting line used for the rotary valve, a peak value of torque during operation of the rotary valve is further prevented.

In an example embodiment, a rotary valve for a thermal management module is provided. The rotary valve has an opening to communicate with the outside of the thermal management module, where the opening of the rotary valve is asymmetric in relation to an axial direction of the rotary valve.

### BRIEF DESCRIPTION OF THE DRAWINGS

These and other objectives and advantages of the present disclosure will be embodied more fully through the following description which refers to the accompanying drawings, wherein identical labels are used in all the drawings to indicate identical or similar components.

FIG. 1 shows a perspective view of a rotary valve, arranged with multiple prior art openings, for a thermal management module.

FIG. 2 shows a development view of example embodiments of openings of a rotary valve of a thermal management module superimposed on corresponding prior art openings.

FIG. 3 shows a development view of the example embodiment openings of FIG. 2 separate from the corresponding prior art openings of FIG. 2.

FIG. 4 shows a development view of an example embodiment of an opening of a rotary valve of a thermal management module superimposed on a corresponding prior art opening.

FIG. 5 shows a development view of the example embodiment opening of FIG. 4 separate from the corresponding prior art opening of FIG. 4.

FIG. 6 shows a cross-sectional view of an example embodiment of a sealing assembly arranged within a housing of a thermal management module.

FIG. 7 shows a view of the sealing assembly and housing of FIG. 6 fitted to a rotary valve with the housing in fluid communication with an external channel.

### DETAILED DESCRIPTION

An example embodiment of a thermal management module is described in detail below with reference to the accompanying drawings.

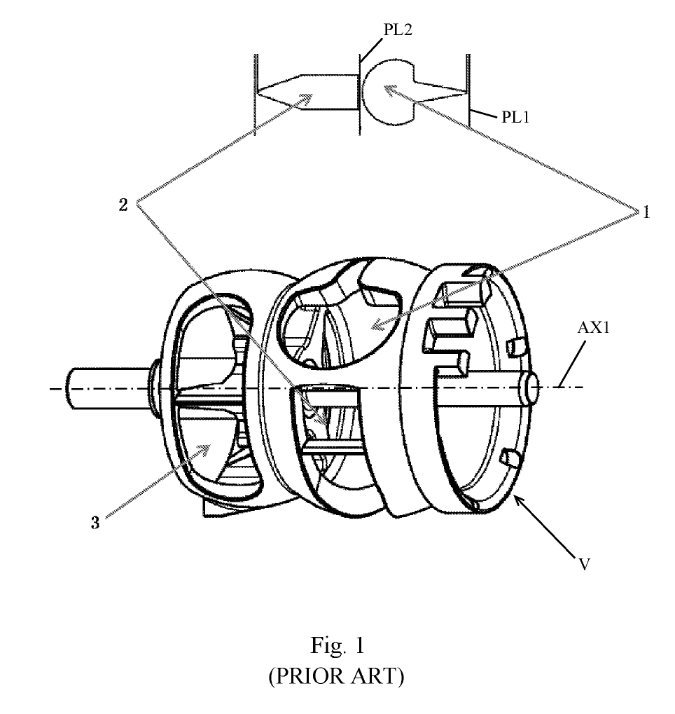

FIG. 1 shows a perspective view of a rotary valve V, arranged with multiple prior art openings, for a thermal management module (not shown). As FIG. 1 shows, the rotary valve V, with a central axis AX1, includes three openings: opening 1, opening 2, and opening 3. Opening 1, opening 2 and opening 3 are each symmetric relative to a corresponding cross section of the rotary valve V. In other words, opening 1, opening 2 and opening 3 each have left-right symmetry in an axial direction of the rotary valve V. Opening 1 and opening 2 are successively arranged in a circumferential direction of the rotary valve V, whereas opening 3 is arranged on one side, in the axial direction of the rotary valve V, of opening 1 and opening 2.

The upper part of FIG. 1 shows a development view of opening 1 and opening 2. It must be explained that to facilitate presentation, the development view the upper part of FIG. 1 has been rotated 90 degrees relative to opening 1 and opening 2 in the lower part of FIG. 1. In the development view, opening 1 is formed substantially in the shape of a push pin, specifically having a base part and a tip part protruding from a straight edge of the base part, the base part having a shape formed by cutting a small part away from a circle. Opening 2 is formed as substantially in the shape of a wedge, specifically having a rectangular base part and an angular part protruding from an edge of the base part.

Prior art opening 1, opening 2 and opening 3 of the rotary valve V of FIG. 1 all have a die parting line that is parallel to the axial direction of the rotary valve. Parting line PL1 for opening 1 and parting line PL2 for opening 2 are shown in the upper development view of FIG. 1.

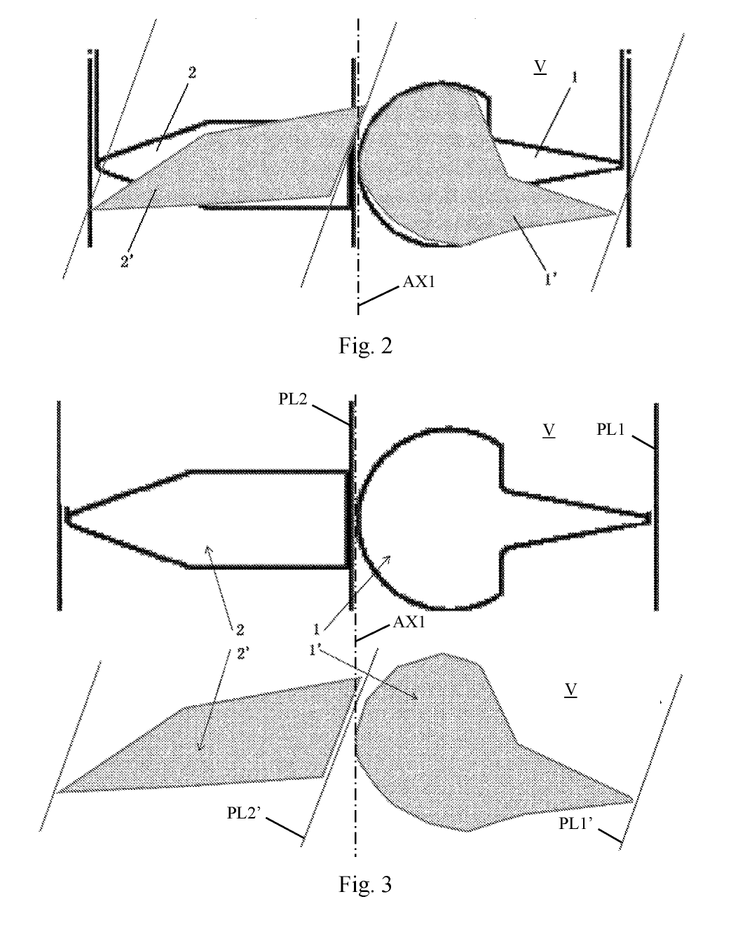

FIG. 2 shows a development view of the rotary valve V arranged with example embodiment openings 1′, 2′ superimposed on corresponding prior art openings 1, 2. As FIG. 2 shows, compared with prior art opening 1 and prior art opening 2, a part of opening 1′ and a part of opening 2′ are offset to one side in an axial direction of the rotary valve. Specifically, a tip part of opening 1′ is offset to one side in the axial direction of the rotary valve, and an angular part of opening 2′ is offset to said side in the axial direction of the rotary valve. Moreover, a substantially rectangular end of opening 2′ is offset to another side, opposite to the side to which the angular part of opening 2′ is offset, in the axial direction of the rotary valve, and is thereby deformed into an acute-angled tip part. Thus, the tip part of opening 1′ is only offset to one side in the axial direction of the rotary valve, whereas the substantially rectangular end and angular part of opening 2′ are offset to two opposite sides in the axial direction of the rotary valve. Thus, opening 1′ and opening 2′ are asymmetric in the axial direction of the rotary valve V.

FIG. 3 shows a development view of the example embodiment openings 1′, 2′ of FIG. 2, separate from the corresponding prior art openings 1, 2. As shown in FIG. 3, compared with the prior art symmetric opening 1, opening 1′ is asymmetric and has a die parting line PL1′ that is inclined relative to the axial direction of the rotary valve V. Similarly, opening 2′ is also asymmetric and has a die parting line PL2′ that is inclined relative to the axial direction of the rotary valve V.

FIG. 4 shows a development view of an example embodiment opening 3′ of the rotary valve V of a thermal management module (not shown) superimposed on a corresponding prior art opening 3. As FIG. 4 shows, prior art opening 3 is formed substantially in the shape of an athletic running track, specifically having a rectangular base part and two substantially semicircular end parts, the two substantially semicircular end parts protruding to two sides, in a direction perpendicular to the axial direction of the rotary valve V, from edges of the base part of the opening 3. Compared with the semicircular end parts of prior art opening 3, end parts of opening 3′ are changed to a pointed shape. Specifically, one end part of opening 3′ is offset to one side in the axial direction of the rotary valve V, whereas another end part of opening 3′ is offset to another side in the axial direction of the rotary valve V. Thus, opening 3′ is asymmetric in the axial direction of the rotary valve V.

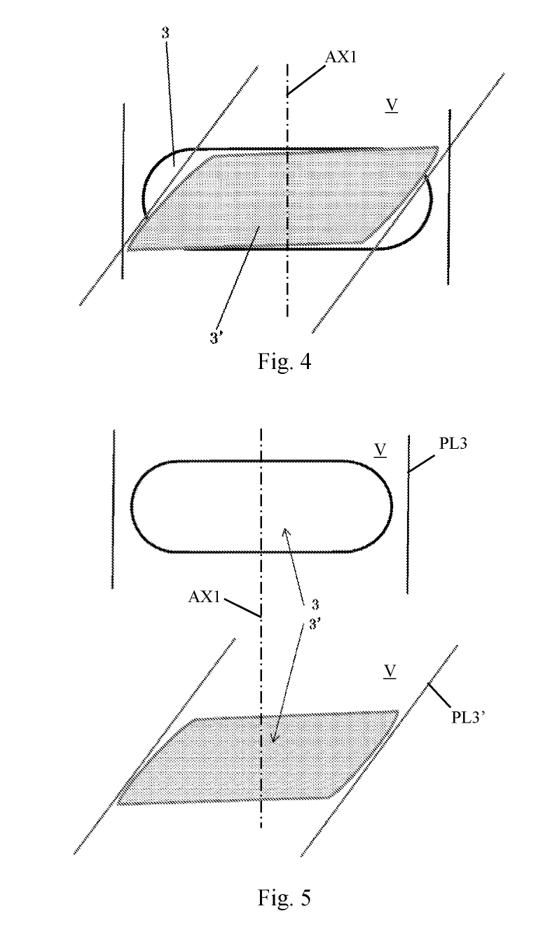

FIG. 5 shows a development view of the example embodiment opening 3′ of FIG. 4 separate from the corresponding prior art opening 3. As shown in FIG. 5, compared with the prior art symmetric opening 3, opening 3′ is asymmetric and has a die parting line PL3 that is inclined relative to the axial direction of the rotary valve.

The rotary valve V may have asymmetric openings on opposite sides in a radial direction thereof. That is, the rotary valve V may have multiple asymmetric openings on opposite sides in a radial direction thereof. In such a case, asymmetric openings in the rotary valve V can be oriented in opposite directions on opposite sides of the rotary valve. Thus, main seals used for opposite channels will rotate in opposite directions, to compensate for an axial reaction force caused by rotation of a main seal at the rotary valve. Furthermore, the rotary valve V may have multiple asymmetric openings on opposite sides in a radial direction oriented in a same direction.

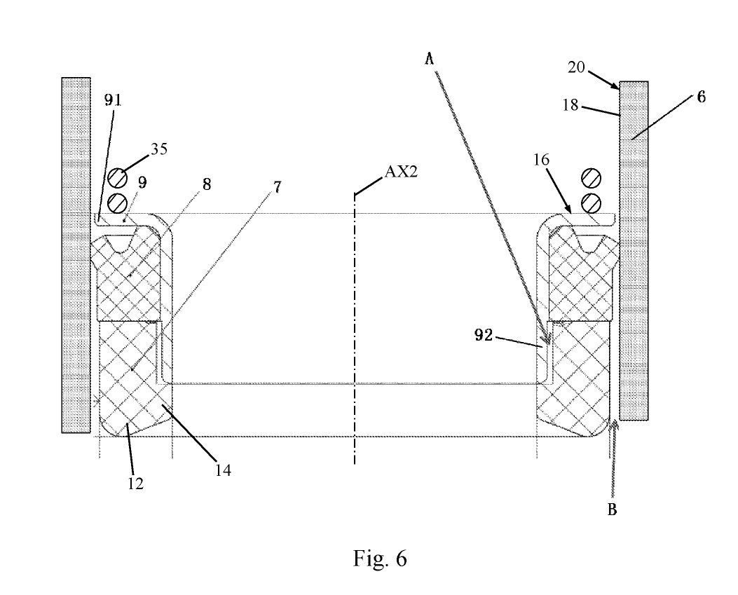

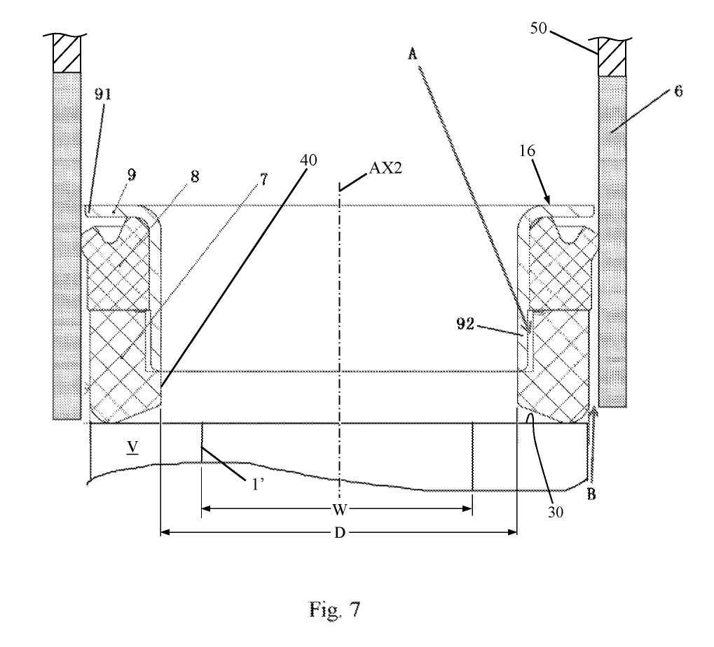

FIG. 6 shows a cross-sectional view of an example embodiment of a sealing assembly 16 arranged within a housing 6 of a thermal management module 20. FIG. 7 shows the cross-sectional view of FIG. 6 together with a portion of a rotary valve V and an external channel 50. The following description should be read in light of FIGS. 6 and 7. As shown in FIG. 6, the sealing assembly 16, having a central axis AX2, is installed in a passageway 18 of the housing 6 of the thermal management module 20. The rotary valve V of the thermal management module 20 is in fluid communication with an external channel 50 via the passageway 18. The sealing assembly 16 comprises a main seal 7, a secondary seal 8 and a seal support 9. The main seal 7 of the sealing assembly 16 can be in direct contact with the rotary valve V, and the seal support 9 can be restrained axially by a spring 35. Specifically, one end (not shown) of the spring 35 is fixed to the housing 6, and another end abuts the seal support 9. The spring ensures that the main seal 7 is pressed against the rotary valve V with sufficient sealing force.

The seal support 9 comprises a hollow cylindrical portion 92 and a flange 91 connected to an axial end of the cylindrical portion 92. There is a space between the cylindrical portion 92 of the seal support 9 and the housing 6 of the thermal management module 20. The main seal 7 and secondary seal 8 are substantially annular, and are both installed in the space between the seal support 9 and the housing 6 of the thermal management module 20. The main seal 7 is in contact with the rotary valve V for the purpose of sealing the rotary valve V; the secondary seal 8 is in contact with both an inner wall of the passageway 18 of the housing 6 and with an outer wall of the cylindrical portion 92 of the seal support 9, for the purpose of achieving sealing between the housing 6 of the thermal management module 20 and the seal support 9. The secondary seal 8 is arranged outside the main seal 7 in a radial direction of the rotary valve V and abuts the main seal 7. Furthermore, the flange 91 of the seal support 9 is arranged inside the secondary seal 8 in a radial direction of the rotary valve V and abuts the secondary seal 8.

A radially inner side of the main seal 7 of the sealing assembly is spaced apart from the cylindrical portion 92 of the seal support 9, so that a radial inner gap A is formed between the two. A radially outer side of the main seal 7 of the sealing assembly is spaced apart from the housing 6 of the thermal management module 20, so that a radial outer gap B is formed between the two. Since the main seal 7 is spaced apart from both the seal support 9 and the housing 6 of the thermal management module 20, the main seal 7 is loose-fitting on the seal support 9 and also loose-fitting in the housing 6 of the thermal management module 20. Thus, the main seal 7 can rotate at the same time as the rotary valve V is rotating. Furthermore, the main seal 7 has a hook portion 14 at an end 12 which is close to the rotary valve V; the main seal 7 is hooked onto an end of the cylindrical portion 92 of the seal support 9 by means of the hook portion 14, so that movement of the main seal 7 in the axial direction of the cylindrical portion 92 is restricted.

By adjusting the external diameter and internal diameter of the main seal 7, a gap can be produced in a radial direction of the main seal 7. A sealing function between the main seal 7 and the secondary seal 8 is realized only in the axial direction of the sealing assembly.

Referring now to FIG. 7, it must be explained that only a part, including the opening 1′, of the rotary valve V is shown; other parts are omitted. The main seal 7 of the sealing assembly 16 is in contact with and pressed against a peripheral surface 30 around the opening 1′ of the rotary valve V, thereby sealing the rotary valve V. During operation of the rotary valve V, a part of an inner hole 40 of the main seal 7 which overlaps the opening 1′ of the rotary valve V can be varied gradually, so the rate of flow through the opening 1′ of the rotary valve V can be varied. When the inner hole 40 of the main seal 7 overlaps the opening of the rotary valve V completely, the rate of flow through the opening 1′ of the rotary valve V is at a maximum.

Furthermore, by adjusting an axial preload of the sealing assembly 16, e.g.

changing the stiffness of the spring 35, rotation of the main seal 7 can be controlled. Due to uniform seal wear and low frictional torque at the rotary valve V, the axial preload is small.

Furthermore, a width W of the opening 1′ of the rotary valve V can be smaller than an internal diameter D of the main seal 7, thereby further reducing a peak value of shifting torque.

Referring to FIG. 3, the die parting line PL1′ of the opening 1′ of the rotary valve V of the thermal management module 20 can be inclined relative to the axial direction of the rotary valve V, i.e. neither parallel nor perpendicular to the axial direction of the rotary valve V; a force/torque causing rotation of the main seal will occur, and a peak value of shifting torque is reduced.

It can be anticipated that various changes and amendments could be made to the present disclosure, without departing from the spirit and scope of the present disclosure as defined in the attached claims.

1. A thermal management module, comprising:
a housing provided with passageway; the passageway having a central axis;
a rotary valve arranged in the housing; the rotary valve having a central axis and at least one opening, the at least one opening being in fluid communication with an external channel via the passageway of the housing; and,
a sealing assembly arranged in the passageway of the housing;
wherein the sealing assembly comprises a main seal, a secondary seal and a seal support; the seal support has a hollow cylindrical portion and a flange connected to an axial end of the hollow cylindrical portion; the main seal and the secondary seal are arranged successively, in an axial direction of the passageway, in a space between the flange and hollow cylindrical portion of the seal support and the housing; the main seal is in contact with the rotary valve in the axial direction of the passageway, and the secondary seal abuts the main seal at one end and abuts the flange at another end in the axial direction of the passageway; and, the main seal rotates during rotation of the rotary valve.

2. The thermal management module of claim 1, wherein a width of the at least one opening of the rotary valve is smaller than an internal diameter of the main seal.

3. The thermal management module of claim 1, wherein the at least one opening of the rotary valve is asymmetric in relation to an axial direction of the rotary valve.

4. The thermal management module of claim 3, wherein the at least one opening comprises:
a first asymmetric opening; and,
a second asymmetric opening on a side opposite the first asymmetric opening in a radial direction of the rotary valve.

5. The thermal management module of claim 4, wherein the first asymmetric opening and the second asymmetric opening are oriented in opposite directions.

6. The thermal management module of claim 3, wherein the at least one opening of the rotary valve has a die parting line that is inclined relative to the axial direction of the rotary valve.

7. (canceled)

8. (canceled)

9. (canceled)

10. (canceled)

11. The thermal management module of claim 1, wherein the main seal is loose-fitting on the seal support of the sealing assembly and loose-fitting in the housing.

12. The thermal management module of claim 1, wherein the main seal forms a radial inner gap with the seal support, and a radial outer gap with the housing.

13. The thermal management module of claim 1, further comprising a spring that abuts the seal support, wherein the spring provides an axial preload of the sealing assembly.

14. The thermal management module of claim 13, wherein a stiffness of the spring is adjusted to control rotation of the main seal.

15. The thermal management module of claim 13, wherein the main seal includes a hook portion to engage an end of the hollow cylindrical portion.

16. A rotary valve for a thermal management module, the rotary valve comprising:
a central axis; and,
at least one opening having a die parting line that is inclined relative to an axial direction of the rotary valve.

17. A rotary valve as claimed in claim 16, wherein the at least one opening is asymmetric in relation to an axial direction of the rotary valve.

18. A rotary valve for a thermal management module, the rotary valve comprising:
a central axis;
at least one opening; and,
wherein, the at least one opening is asymmetric in relation to an axial direction of the rotary valve.

19. The rotary valve of claim 18, wherein the at least one opening comprises:
a first asymmetric opening; and,
a second asymmetric opening on a side opposite the first asymmetric opening in a radial direction of the rotary valve.

20. The rotary valve of claim 19, wherein the first asymmetric opening and the second asymmetric opening are oriented in opposite directions.

21. The rotary valve of claim 19, wherein the first asymmetric opening and the second asymmetric opening are oriented in a same direction.

22. A thermal management module comprising:
a housing provided with a passageway; the passageway having a central axis;
a rotary valve arranged in the housing, the rotary valve having at least one opening; and,
a sealing assembly arranged in the passageway, the sealing assembly comprising:
a main seal in contact with the rotary valve;
a secondary seal; and,
a seal support having:
a hollow cylindrical portion; and,
a flange connected to an axial end of the hollow cylindrical portion; and,
the main seal and secondary seal are arranged successively in an axial direction of the passageway in a space between the seal support and the housing;
the secondary seal abuts the main seal at one end and abuts the flange at another end; and,
wherein the main seal rotates during rotation of the rotary valve.
